(19) United States
(12) Patent Application Publication
(10) Pub. No.: US 2009/0056231 A1
(43) Pub. Date: Mar. 5, 2009

(54) Copper CMP composition containing ionic polyelectrolyte and method

(76) Inventors: Daniela White, Oswego, IL (US); Jason J. Keleher, Joliet, IL (US); John Parker, Naperville, IL (US)

Correspondence Address: STEVEN WESEMAN;ASSOCIATE GENERAL COUNSEL, I.P., CABOT MICROELECTRONICS CORPORATION, 870 NORTH COMMONS DRIVE, AURORA, IL, 60504, US

(21) Appl. No.: 11/895,896

(22) Filed: Aug. 28, 2007

(51) Int. Cl. C09K 3/14; B24B 1/00

(52) U.S. Cl. 51/298; 451/28

(57) ABSTRACT

The CMP compositions of the invention comprise not more than about 1 percent by weight of a particulate abrasive, a polyelectrolyte, which preferably has a weight average molecular weight of at least about 10,000 grams-per-mole (g/mol), a copper-complexing agent, and an aqueous carrier therefor. The polyelectrolyte can be an anionic polymer (e.g., an acrylate polymer or copolymer) or a cationic polymer (e.g., poly(2-[(methacryloyloxy)ethyl] trimethyl-ammonium halide). When an anionic polyelectrolyte is utilized, the copper-complexing agent preferably comprises an amino polycarboxylate compound (e.g., iminodiacetic acid or a salt thereof). When a cationic polyelectrolyte is utilized, the copper-complexing agent preferably comprises an amino acid (e.g., glycine). Preferably, the particulate abrasive comprises metal oxide such as titanium dioxide or silicon dioxide. Methods of polishing copper-containing substrates with the compositions are also disclosed.

### FIELD OF THE INVENTION

This invention relates to polishing compositions and methods for polishing a copper-containing substrate. More particularly, this invention relates to chemical-mechanical polishing compositions containing an ionic polyelectrolyte and a copper-complexing agent, as well as to polishing methods utilizing the compositions.

### BACKGROUND OF THE INVENTION

Many compositions and methods for chemical-mechanical polishing (CMP) the surface of a substrate are known in the art. Polishing compositions (also known as polishing slurries, CMP slurries, and CMP compositions) for polishing metal-containing surfaces of semiconductor substrates (e.g., integrated circuits) typically contain abrasives, various additive compounds, and the like, and frequently are used in combination with an oxidizing agent. Such CMP compositions are often designed for removal of specific substrate materials such as metals (e.g., tungsten or copper), insulators (e.g., silicon dioxide, such as plasma-enhanced tertraethylorthosilicate (PETEOS)-derived silica), and semiconductive materials (e.g., silicon or gallium arsenide).

In conventional CMP techniques, a substrate carrier (polishing head) is mounted on a carrier assembly and positioned in contact with a polishing pad in a CMP apparatus. The carrier assembly provides a controllable pressure (down force) to urge the substrate against the polishing pad. The pad and carrier, with its attached substrate, are moved relative to one another. The relative movement of the pad and substrate serves to abrade the surface of the substrate to remove a portion of the material from the substrate surface, thereby polishing the substrate. The polishing of the substrate surface typically is further aided by the chemical activity of the polishing composition (e.g., by oxidizing and/or complexing agents present in the CMP composition) and the mechanical activity of an abrasive suspended in the polishing composition. Typical abrasive materials include, for example, silicon dioxide (silica), cerium oxide (ceria), aluminum oxide (alumina), zirconium oxide (zirconia), titanium dioxide (titania), and tin oxide.

The abrasive desirably is suspended in the CMP composition as a colloidal dispersion, which preferably is colloidally stable. The term “colloid” refers to the suspension of abrasive particles in the liquid carrier. As used herein, the term “colloidal stability” and grammatical variations thereof, is to be construed as referring to the maintenance of the suspension of abrasive particles during a selected period of time with minimal settling. In the context of this invention, an abrasive suspension is considered colloidally stable if, when the suspension is placed into a 100 mL graduated cylinder and allowed to stand without agitation for about 2 hours, the difference between the concentration of particles in the bottom 50 mL of the graduated cylinder ([B] in terms of g/mL) and the concentration of particles suspended in the top 50 mL of the graduated cylinder ([T] in terms of g/mL) divided by the initial concentration of particles suspended in the abrasive composition ([C] in terms of g/mL) is less than or equal to about 0.5 (i.e., ([B]−[T])/[C]≦0.5). The value of ([B]−[T])/[C] desirably is less than or equal to about 0.3, and preferably is less than or equal to about 0.1.

U.S. Pat. No. 5,527,423 to Neville et al., for example, describes a method for chemically-mechanically polishing a metal layer by contacting the surface of the metal layer with a polishing slurry comprising high purity fine metal oxide particles suspended in an aqueous medium. Alternatively, the abrasive material may be incorporated into the polishing pad. U.S. Pat. No. 5,489,233 to Cook et al. discloses the use of polishing pads having a surface texture or pattern, and U.S. Pat. No. 5,958,794 to Bruxvoort et al. discloses a fixed abrasive polishing pad.

For copper CMP applications it often is desirable to use a relatively low-solids dispersion (i.e., having an abrasive concentration at a total suspended solids (TSS) level of about 1 percent by weight or less), which is chemically reactive toward copper. Chemical reactivity can be modulated through the use of oxidizing agents, complexing agents, corrosion inhibitors, pH, ionic strength, and the like. Balancing the chemical reactivity and mechanical abrasive properties of the CMP slurry can be complicated. Many commercial copper CMP slurries are highly chemically reactive, providing high copper static etch rates, controlled, at least in part, by organic corrosion inhibitors, such as benzotriazole (BTA), other organic triazoles, and imidazoles. Many such CMP compositions do not provide good corrosion control after polishing, however. The common commercial copper CMP slurries also frequently suffer from dishing-erosion, relatively high defectivity, and surface topography problems. In addition, many conventional copper CMP slurries utilize copper-complexing ligands that produce highly water soluble copper complexes, which can lead to undesirable formation of copper hydroxide in the presence of hydrogen peroxide. Formation of copper hydroxide can lead to deposition of copper oxide on the surface of the substrate, which, in turn, can interfere with the polishing performance of the slurry (see FIG. 1 for an illustration of this process).

There is an ongoing need to develop new copper CMP compositions and methods utilizing relatively low-solids CMP slurries that provide a reduced level of dishing-erosion and defectivity, high copper removal rates, as well as superior corrosion protection and surface inhibition compared to conventional CMP slurries. There is also a need for copper CMP compositions that minimize the deposition of copper oxide on the surface of the substrate during CMP in the presence of oxidizing agents. The present invention provides such improved CMP compositions and methods. These and other advantages of the invention, as well as additional inventive features, will be apparent to those of ordinary skill in the art from the description of the invention provided herein.

### SUMMARY OF THE INVENTION

The present invention provides chemical-mechanical polishing (CMP) compositions and methods suitable for polishing a copper-containing substrate (e.g., a semiconductor wafer) utilizing a relatively low-solids (i.e., low TSS) abrasive slurry. The CMP compositions of the invention comprise not more than about 1 percent by weight of a particulate abrasive (e.g., about 0.01 to about 1 percent by weight), a polyelectrolyte that preferably has a weight average molecular weight of at least about 10,000 grams-per-mole (g/mol), a copper-complexing agent, all of which are dissolved or suspended in an aqueous carrier. The polyelectrolyte can be an anionic polymer, a cationic polymer, or an amphoteric polymer. When an anionic or amphoteric polyelectrolyte is utilized, the copper-complexing agent preferably comprises an amino polycarboxylilic acid compound (e.g., iminodiacetic acid or a salt thereof). When a cationic polyelectrolyte is utilized, the copper-complexing agent preferably comprises an amino acid (e.g., glycine). Preferably, the particulate abrasive comprises a metal oxide such as titanium dioxide or silicon dioxide.

The present invention also provides a CMP method for polishing a copper-containing substrate, which comprises abrading a surface of the substrate with a CMP composition of the invention, optionally in the presence of an oxidizing agent such as hydrogen peroxide.

### BRIEF DESCRIPTION OF THE DRAWINGS

FIG. 1 shows a schematic representation of copper oxide formation from soluble copper complexes in the presence of hydrogen peroxide.

FIG. 2 shows a schematic representation of an abrasive particle having a polyelectrolyte and a copper-complexing agent (glycine) adsorbed on the surface of the particle.

FIG. 3 shows bar graphs of zeta potential and particle size for CMP compositions comprising colloidal silica in the presence and absence of a polyelectrolyte and a copper-complexing agent.

FIG. 4 shows bar graphs of zeta potential and particle size for CMP compositions comprising titanium dioxide in the presence and absence of a polyelectrolyte and a copper-complexing agent.

FIG. 5 illustrates potential interactions and passivating film effects produced by the polyelectrolyte and the complexing agent in the compositions of the invention.

FIG. 6 illustrates a possible mechanism by which iminodiacetic acid may act as a reducing agent for Cu(+2) to form surface passivating complexes.

FIG. 7 presents bar graphs of copper removal rates (Cu RR in Å/min) for compositions of the invention including colloidal silica, poly(Madquat), and glycine.

FIG. 8 presents bar graphs of copper removal rates (Cu RR in Å/min) for compositions of the invention including titanium dioxide, poly(Madquat), and glycine.

FIG. 9 shows a surface plot of copper removal rate (RR) versus hydrogen peroxide level and polyelectrolyte level obtained with compositions including about 1 percent by weight of iminodiacetic acid, varying amounts of poly(acrylic acid-co-acrylamide) (“PAA-PAcAm”), and about 0.1 percent by weight of colloidal silica.

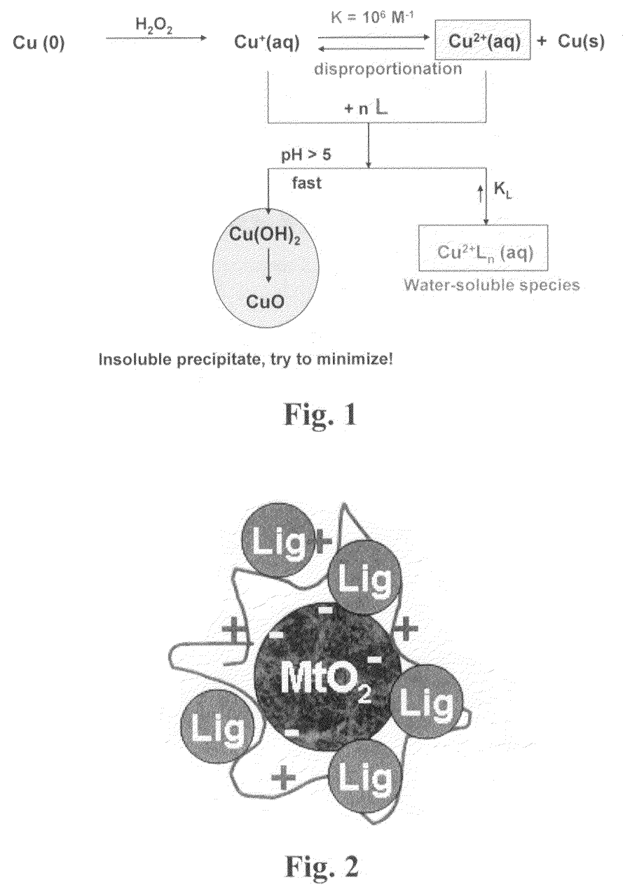

### DETAILED DESCRIPTION A PREFERRED EMBODIMENT

The CMP compositions of the invention comprise not more than about 1 percent by weight of a particulate abrasive, a polyelectrolyte, a copper-complexing agent, and an aqueous carrier. The compositions provide for relatively high copper removal rates, relatively low defectivity, and good corrosion protection and surface passivation.

Particulate abrasives useful in the CMP compositions and methods of the invention include any abrasive material suitable for use in CMP of semiconductor materials. Non-limiting examples of suitable abrasive materials include silica (e.g., fumed silica and/or colloidal silica), alumina, titania, ceria, zirconia, or a combination of two or more of the foregoing abrasives, which are well known in the CMP art. Preferred abrasives include silicon dioxide, particularly colloidal silica, as well as titanium dioxide. The abrasive material is present in the CMP slurry at a concentration of not more than about 1 percent by weight (i.e., ≦10,000 parts-per-million, ppm). Preferably, the abrasive material is present in the CMP composition at a concentration in the range of about 0.01 to about 1 percent by weight, more preferably in the range of about 0.1 to about 0.5 percent by weight. The abrasive material preferably has a mean particle size of not more than about 100 nm, as determined by laser light scattering techniques, which are well known in the art.

The polyelectrolyte component of the CMP compositions can comprise any suitable, relatively high molecular weight ionic polymer (e.g., an anionic polymer, a cationic polymer, and/or an amphoteric polymer). Preferred anionic polymers are polycarboxylate materials such as acrylic acid polymers or copolymers. Preferred amphoteric polymers include copolymers of an anionic monomer (e.g., acrylate) with an amino or quaternary ammonium-substituted monomer; as well as homopolymers or copolymers comprising zwitterionic monomer units (e.g., betaine polymers), and carboxylic acid-carboxamide polymers. As used herein and in the appended claims, the terms “polycarboxylate”, “acrylate”, “poly(carboxylic acid)”, “acrylic acid” an any grammatically similar terms relating to the polyelectrolyte, a monomer, or a copper-complexing agent, are to be construed as referring to the acid form, the salt form, or a combination of acid and salt form (i.e., a partially neutralized form) of the material, which are functionally interchangeable with one another.

The polyelectrolytes are film forming materials that are capable of adhering to the surface of the abrasive particles. The polyelectrolyte generally will be selected to complement the net charge on the abrasive particles (e.g., as determined by the zeta potential). CMP compositions in which the abrasive particles are negatively charged generally will utilize a cationic polyelectrolyte, whereas an anionic polyelectrolyte generally will be utilized with abrasives that bear a net positive charge. Alternatively, an amphoteric polyelectrolyte, which can bear a net positive or a net negative charge depending on the pH of the medium, could be used with either positively or negatively charged particles, so long as the charges are complementary at the pH of the medium.

Preferably, the polyelectrolyte is present in the compositions of the invention at a concentration in the range of about 50 to about 1000 ppm, more preferably about 100 to about 250 ppm. The polyelectrolytes preferably have a weight average molecular weight (M_{w}) of at least about 10,000 g/mol, more preferably in the range of about 10,000 to about 500,000 g/mol. In some preferred embodiments, a cationic polyelectrolyte has a M_{w} of at least about 15,000 g/mol. In other preferred embodiments, an anionic or amphoteric polyelectrolyte has a M_{w} of at least about 50,000 g/mol.

Non-limiting examples of useful anionic polyelectrolytes include acrylate polymers such as polyacrylates, and acrylate copolymers, such as poly(acrylic acid-co-acrylic ester) copolymers; and/or salts thereof. Preferred salts are alkali metal salts, such as sodium or potassium salts.

Non-limiting examples of useful cationic polyelectrolytes include, without limitation, quaternary ammonium-substituted polymers, such as a polymer of a 2-[(methacryloyloxy)ethyl]trimethylammonium halide (e.g., chloride) monomer (commonly known as “Madquat” monomer), copolymers derived from a quaternary ammonium-substituted monomer (e.g., Madquat) in combination with an amino-substituted monomer, and/or a nonionic monomer; as well as polyamines, such as poly(vinyl amine) and poly(allyl amine), or copolymers of amino-substituted monomers with nonionic monomers; and/or salts thereof. Preferred salts are inorganic acid addition salts such as halides (e.g., chloride or bromide salts), sulfates, bisulfates, nitrates, and the like, as well as organic acid addition salts, such as acetates, and the like. A preferred cationic polyelectrolyte is poly(Madquat) having a M_{w} or at least about 15,000 g/mol.

Non-limiting examples of useful amphoteric polyelectrolytes include poly(aminocarboxylic acids), such as poly(amino acids), polypeptides, and relatively low molecular weight proteins; copolymers of vinyl or allyl amine monomers with carboxylic acid monomers (e.g., acrylic acid); and copolymers of carboxylic acid monomers and amide monomers, such as poly(acrylic acid-co-acrylamide); and/or salts thereof. A preferred amphoteric polyelectrolyte is poly(acrylic acid-co-acrylamide) and salts thereof (PAA-PAM), preferably having a molar ratio of acrylic acid to acrylamide monomer of about 60:40, and a M_{w} of at least about 50,000 g/mol, more preferably at least about 200,000 g/mol. Another preferred amphoteric polyelectrolyte is a polymer bearing amine and carboxylic acid functional groups, which is sold under the trade name DISPERBYK® 191 (BYK Additives & Instruments; Wesel, Germany), and which reportedly has an acid number of about 30 mg KOH/g (ASTM D974) and an amine value of about 20 mg KOH/g (ASTM D2073-92).

Copper-complexing agents are well known in the art, and include amino polycarboxylates (i.e., compounds having at least one amino substituent and 2 or more carboxylic acid groups), amino acids (i.e., compounds having a single amino substituent and a single carboxylic acid group), hydroxyl polycarboxylates (i.e., compounds having at least one hydroxyl substituent and two or more carboxylic acid groups), salts thereof, and the like. Non-limiting examples of copper-complexing agents that are useful in the compositions of the present invention include amino acids, such as glycine, other α-amino acids, β-amino acids, and the like; amino polycarboxylates, such as, iminodiacetic acid (IDA), ethylenediaminedisuccinic acid (EDDS), iminodisuccinic acid (IDS), ethylenediaminetetraacetic acid (EDTA), nitrilotriacetic acid (NTA), and/or salts thereof, and the like; hydroxyl polycarboxylic acids, such as citric acid, tartaric acid, and/or salts thereof, and the like, as well as other metal chelating agents, such as phosphonocarboxylic acids, aminophosphonic acids, and/or salts thereof, and the like. Preferably, the copper-complexing agent is present in the composition at a concentration in the range of about 0.5 to about 1.5 percent by weight.

The aqueous carrier preferably is water (e.g., deionized water), and can optionally include one or more water-miscible organic solvent, such as an alcohol.

The CMP compositions of the invention preferably have a pH in the range of about 5 to about 10. The CMP compositions optionally can comprise one or more pH buffering materials, for example, ammonium acetate, disodium citrate, and the like. Many such pH buffering materials are well known in the art.

The CMP compositions of the invention also optionally can comprise one or more additives, such as a nonionic surfactant, a rheological control agent (e.g., a viscosity enhancing agent or coagulant), a biocide, a corrosion inhibitor, an oxidizing agent, a wetting agent, and the like, many of which are well known in the CMP art.

In one preferred embodiment, the CMP composition comprises not more than about 1 percent by weight of a particulate abrasive, about 100 to about 1000 ppm of an anionic or amphoteric polyelectrolyte (preferably about 100 to about 250 ppm), which preferably has a weight average molecular weight of at least about 50,000 g/mol, about 0.5 to about 1.5 percent by weight of an amino polycarboxylate copper-complexing agent, and an aqueous carrier therefor. A preferred amphoteric polyelectrolyte for use in this embodiment is poly(acrylic acid-co-acrylamide) and/or a salt thereof (PAA-PAM), having a molar ratio of acrylic acid to acrylamide monomer of about 60:40, and a M_{w} of at least about 50,000 g/mol, more preferably at least about 200,000 g/mol. Another preferred amphoteric polyelectrolyte is DISPERBYK® 191 (BYK Additives & Instruments; Wesel, Germany), described above.

In another preferred embodiment, the CMP composition comprises not more than about 1 percent by weight of a particulate abrasive, about 10 to about 150 ppm (preferably about 50 to about 150 ppm) of a cationic polyelectrolyte (preferably having a weight average molecular weight of at least about 15,000 g/mol), about 0.5 to about 1.5 percent by weight (preferably about 0.5 to about 1 percent by weight) of an amino acid copper-complexing agent, and an aqueous carrier therefor. A preferred cationic polyelectrolyte for use in this embodiment is poly(Madquat), having a M_{w} of at least about 15,000 g/mol.

The CMP compositions of the invention can be prepared by any suitable technique, many of which are known to those skilled in the art. The CMP composition can be prepared in a batch or continuous process. Generally, the CMP composition can be prepared by combining the components thereof in any order. The term “component” as used herein includes individual ingredients (e.g., abrasives, polyelectrolytes, complexing agents, acids, bases, aqueous carriers, and the like) as well as any combination of ingredients. For example, an abrasive can be dispersed in water, and the polyelectrolyte and copper-complexing agent can be added, and mixed by any method that is capable of incorporating the components into the CMP composition. Typically, an oxidizing agent can be added just prior to initiation of polishing. The pH can be adjusted at any suitable time.

The CMP compositions of the present invention also can be provided as a concentrate, which is intended to be diluted with an appropriate amount of water or other aqueous carrier prior to use. In such an embodiment, the CMP composition concentrate can include the various components dispersed or dissolved in the aqueous carrier in amounts such that, upon dilution of the concentrate with an appropriate amount of additional aqueous carrier, each component of the polishing composition will be present in the CMP composition in an amount within the appropriate range for use.

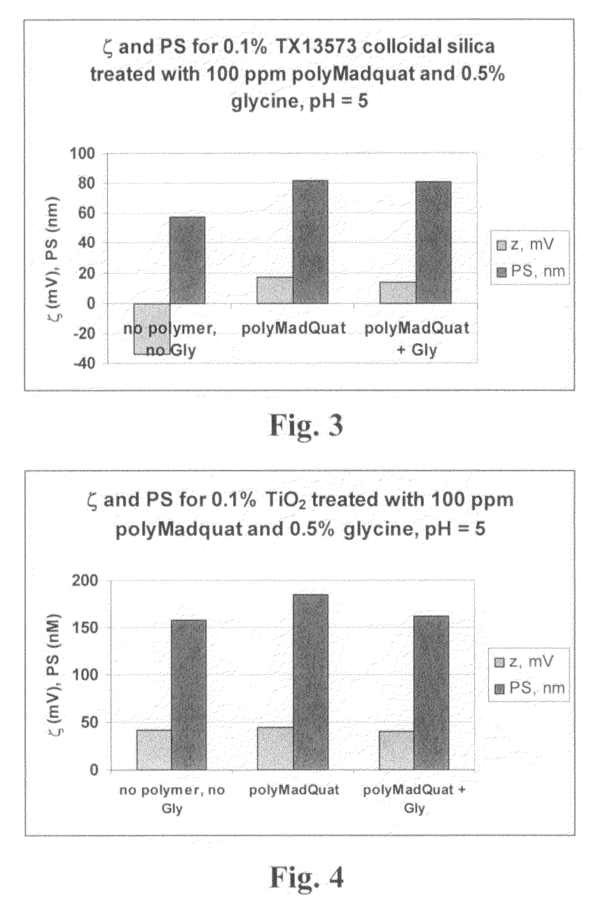

Not wishing to be bound by theory, it is believed that the abrasive particles interact with the polyelectrolyte by ionic and nonionic interactions, such that the polymer adheres to, or adsorbs onto the surface of the abrasive particles. Evidence of such adsorption can be obtained by monitoring the zeta potential of the particles and noting the change in zeta potential as the polyelectrolyte is added to the abrasive. The complexing agent can become reversibly bound to the surface of the polymer-coated absorbent. For example, a negatively-charged abrasive (e.g., colloidal silica at pH 6) was added to an aqueous mixture of poly(Madquat) and glycine. The resulting particle/adsorbed polymer/glycine complex is depicted schematically in FIG. 2. The bar graphs in FIG. 3 show zeta potential and particle size for 0.1 percent by weight colloidal silica particles (mean particle size of about 60 nm) in the presence and absence of about 100 ppm of poly(Madquat) having a M_{w} of about 15,000 g/mol, and 0.5 percent by weight glycine at pH 5. The apparent particle size increased upon addition of the polymer, likely due to interactions between the polymer-adsorbed particles. FIG. 4 shows the results of similar experiments utilizing about 0.1 percent by weight titanium dioxide in place of the colloidal silica. A similar trend in apparent particle size was observed.

CMP compositions of the present invention containing an anionic or amphoteric polyelectrolyte and an amino polycarboxylate copper-complexing agent also can passivate the copper surface of the polished substrate. Copper static etch rates (SER) were determined for compositions comprising a poly(acrylate-co-acrylamide) polyelectrolyte (PAA-PAM; M_{w} of about 200,000 g/mol, having a molar ratio of acrylate to acrylamide of about 60:40), at pH 6, with about 1 percent by weight hydrogen peroxide, in order to evaluate the relative effects of an amino acid (glycine) versus an amino polycarboxylate (iminodiacetic acid, IDA) copper-complexing agent on surface passivation in the presence of an amphoteric polyelectrolyte. The SER was determined by submerging a copper wafer in about 200 grams of the CMP slurry for about 10 to 30 minutes. The wafer thickness after submersion was subtracted from the fresh wafer thickness, and the difference (in Å) was divided by the time period of submersion (in minutes) to obtain the SER (in Å/min). Compositions containing various levels of IDA were compared to compositions containing the same concentrations of glycine. In each case, the static etch rates obtained with the glycine compositions were significantly higher than the static etch rates obtained with IDA compositions (see Table 1) at corresponding levels of polyelectrolyte and complexing agent. These results indicate that the PAA-PAM copolymer provides a significantly better passivating film in the presence of an amino polycarboxylate (IDA) relative to an amino acid (glycine). These results were verified electrochemically, as well.

TABLE 1

| Composition | SER (Å/min) |
|---|---|
| 100 ppm PAA-PAM, 1,000 ppm glycine | 60 |
| 100 ppm PAA-PAM, 1,000 ppm IDA | 22 |
| 1,000 ppm PAA-PAM, 1,000 ppm glycine | 422 |
| 1,000 ppm PAA-PAM, 1,000 ppm IDA | 26 |
| 100 ppm PAA-PAM, 10,000 ppm glycine | 450 |
| 100 ppm PAA-PAM, 10,000 ppm IDA | 232 |
| 1,000 ppm PAA-PAM, 10,000 ppm glycine | 374 |
| 1,000 ppm PAA-PAM, 10,000 ppm IDA | 14.3 |
| 550 ppm PAA-PAM, 5,500 ppm glycine | 200 |
| 550 ppm PAA-PAM, 5,500 ppm IDA | 118.8 |

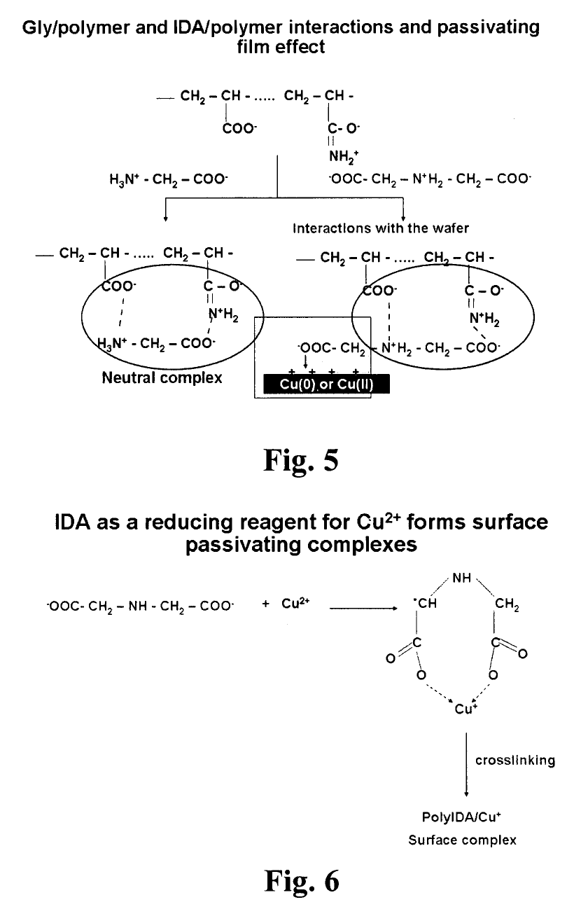

FIG. 5 illustrates potential polymer-complexing agent interactions and passivating film effects produced by iminodiacetic acid (IDA) in conjunction with a poly(acrylate-co-acrylamide) polyelectrolyte (PAA-PAM, M_{w} of about 200,000 g/mol, about 60:40 molar ratio of acrylate to acrylamide), compared to the combination of the same polyelectrolyte with glycine. The combination of IDA with PAA-PAM provided good inhibition, good surface passivation, and a relatively low static etch rate, while the combination of glycine with PAA-PAM produced relatively higher static etch rates, higher levels of corrosion, and no surface passivation or film formation. Mechanistically, the IDA may act as a reducing agent for Cu(+2) to form surface passivating complexes (see FIG. 6). It is possible that glycine forms a neutral complex with the polyelectrolyte and the abrasive particles, whereas IDA forms an anionic complex, which is able to electrostatically interact with the substrate surface and form a thin passivating layer, which is easily removed during the polishing process.

The CMP compositions of the present invention can be used to polish any suitable substrate, and are especially useful for polishing substrates comprising metallic copper.

In another aspect, the present invention provides a method of polishing a copper-containing substrate by abrading a surface of the substrate with a CMP composition of the invention. Preferably, the CMP composition is utilized to polish the substrate in the presence of an oxidizing agent, such as hydrogen peroxide. Other useful oxidizing agents include, without limitation, inorganic and organic peroxo-compounds, bromates, nitrates, chlorates, chromates, iodates, potassium ferricyanide, potassium dichromate, iodic acid and the like. Non-limiting examples of compounds containing at least one peroxy group include hydrogen peroxide, urea hydrogen peroxide, percarbonates, benzoyl peroxide, peracetic acid, di-t-butyl peroxide, monopersulfates (SO₅²⁻), and dipersulfates (S₂O₈²⁻). Non-limiting examples of other oxidizing agents, which contain an element in its highest oxidation state, include periodic acid, periodate salts, perbromic acid, perbromate salts, perchloric acid, perchlorate salts, perboric acid, perborate salts, and permanganates. Preferably, the oxidizing agent is utilized at a concentration in the range of about 0.1 to about 5 percent by weight, based on the combined weight of the oxidizing agent and the CMP composition.

The CMP methods of the present invention are particularly suited for use in conjunction with a chemical-mechanical polishing apparatus. Typically, the CMP apparatus comprises a platen, which, when in use, is in motion and has a velocity that results from orbital, linear, and/or circular motion. A polishing pad is mounted on the platen and moves with the platen. A carrier assembly holds a substrate to be polished in contact with the pad and moves relative to the surface of the polishing pad, while urging the substrate against the pad at a selected pressure (down force) to aid in abrading the surface of the substrate. A CMP slurry is pumped onto the polishing pad to aid in the polishing process. The polishing of the substrate is accomplished by the combined abrasive action of the moving polishing pad and the CMP composition of the invention present on the polishing pad, which abrades at least a portion of the surface of the substrate, and thereby polishes the surface.

The methods of the present invention can utilize any suitable polishing pad (e.g., polishing surface). Non-limiting examples of suitable polishing pads include woven and non-woven polishing pads, which can include fixed abrasives, if desired. Moreover, suitable polishing pads can comprise any suitable polymer having a hardness, thickness, compressibility, ability to rebound upon compression, and/or compression modulus, which is suitable for polishing a given substrate. Non-limiting examples of suitable polymers include, polyvinylchlorides, polyvinylfluorides, nylons, polymeric fluorocarbons, polycarbonates, polyesters, polyacrylate esters, polyethers, polyethylenes, polyamides, polyurethanes, polystyrenes, polypropylenes, coformed products thereof, and combinations thereof.

Desirably, the CMP apparatus further comprises an in situ polishing endpoint detection system, many of which are known in the art. Techniques for inspecting and monitoring the polishing process by analyzing light or other radiation reflected from a surface of the workpiece are known in the art. Such methods are described, for example, in U.S. Pat. No. 5,196,353 to Sandhu et al., U.S. Pat. No. 5,433,651 to Lustig et al., U.S. Pat. No. 5,949,927 to Tang, and U.S. Pat. No. 5,964,643 to Birang et al. Desirably, the inspection or monitoring of the progress of the polishing process with respect to a workpiece being polished enables the determination of the polishing end-point, i.e., the determination of when to terminate the polishing process with respect to a particular workpiece.

The following non-limiting examples further illustrate various aspects of the present invention.

### EXAMPLE 1

### Evaluation of CMP Compositions Comprising a Cationic Polyelectrolyte and an Amino Acid Copper-Complexing Agent

CMP compositions of the invention were utilized to polish 4-inch diameter copper blanket wafers in the presence of about 1 percent by weight of hydrogen peroxide. Two of the compositions included about 0.1 percent by weight of colloidal silica (mean particle size of about 60 nm), about 100 ppm of poly(Madquat) having a weight average molecular weight of about 15,000 g/mol, in combination with either 0.05 or 0.5 percent by weight of glycine. Two other compositions included about 0.1 percent by weight of titanium dioxide and about 100 ppm of the poly(Madquat), in combination with either 0.05 or 1 percent by weight of glycine. Comparisons were made to compositions containing just the abrasive, the abrasive plus the polyelectrolyte (with no glycine), and abrasive plus glycine (no polyelectrolyte). Each of the compositions had a pH of about 5. The wafers were polished on a Logitech Model II CDP polisher (Logitech Ltd., Glasgow, UK) under the following operating conditions: a D100 polishing pad, platen speed of about 80 revolutions-per-minute (rpm), carrier speed of about 75 rpm, down force of about 3 pounds-per-square inch (psi), and a slurry flow rate of 200 milliliters-per-minute (mL/min).

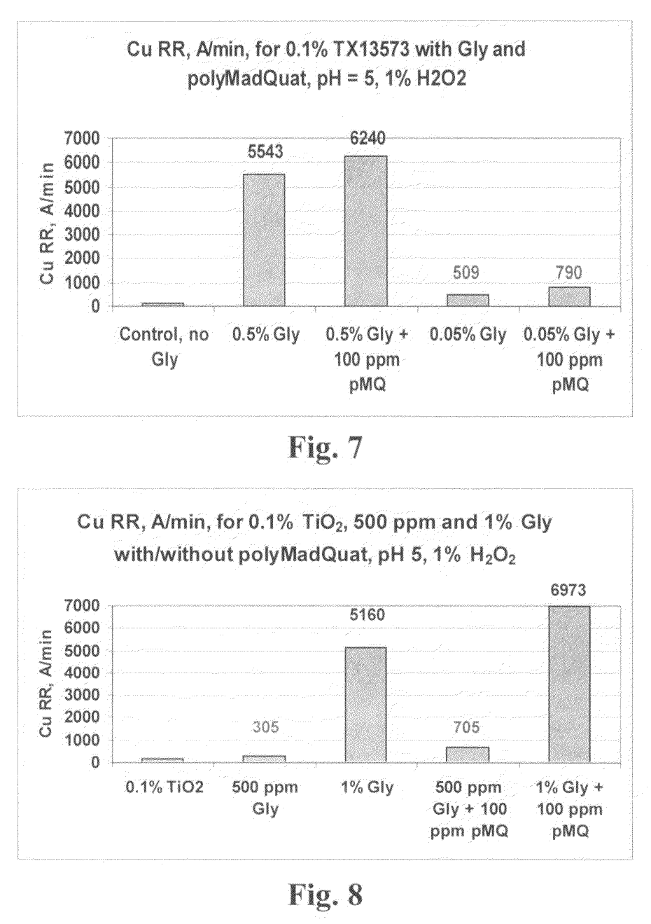

The observed copper removal rates (Cu RR in Å/min) for the silica compositions are presented graphically in FIG. 7, while the copper removal rates for the titanium dioxide compositions are shown in FIG. 8. The data in FIG. 7 and FIG. 8 indicate that compositions containing the cationic polyelectrolyte in combination with glycine surprisingly exhibited significantly improved copper removal rates compared to compositions of abrasive alone, abrasive plus polyelectrolyte, and abrasive plus glycine.

### EXAMPLE 2

### Evaluation of CMP Compositions Comprising an Amphoteric Polyelectrolyte and an Amino Polycarboxylate Copper-Complexing Agent

CMP compositions of the invention were utilized to polish 4-inch diameter copper blanket wafers. The compositions included about 0.1 percent by weight of colloidal silica abrasive (mean particle size of about 60 nm), about 100 to about 1000 ppm of PAA-PAM copolymer having a weight average molecular weight of about 200,000 g/mol and a molar ratio of PAA to PAM of about 60:40, in combination with about 1 percent by weight of IDA. The wafers were polished on a Logitech Model II CDP polisher (Logitech Ltd., Glasgow, UK) in the presence of hydrogen peroxide at various concentrations in the range of about 0.8 to about 1.6 percent by weight, at a pH in the range of about 5 to about 7, under the following operating conditions: a D100 polishing pad, platen speed of about 80 rpm, carrier speed of about 75 rpm, down force of about 3 psi, and a slurry flow rate of 200 mL/min.

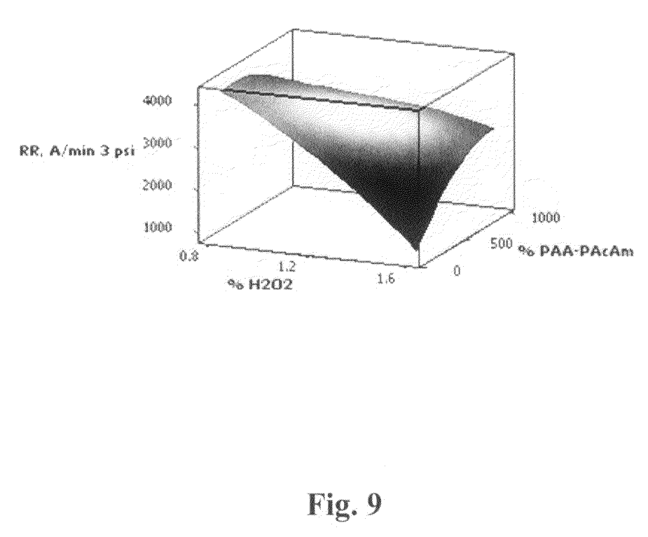

The observed copper removal rates (Cu RR in Å/min) are presented graphically in FIG. 9. The data in FIG. 9 indicate that compositions containing the PAA-PAM copolymer in combination with IDA provided the highest copper removal rates (about 4000 Å/min) at 0.8 percent hydrogen peroxide (pH 5) with less than 500 ppm of PAA-PAM present, although very good rates (about 2500 to about 3000 Å/min) also were obtained with 1.6 percent by weight hydrogen peroxide and 1000 ppm of PAA-PAM.

### EXAMPLE 3

### Evaluation of Hydrogen Peroxide and Periodic Acid as Oxidizing Agents for Use with CMP Compositions of the Invention

A CMP composition of the invention was utilized to polish 4-inch diameter copper blanket wafers. The composition included about 0.1 percent by weight of colloidal silica abrasive (mean particle size of about 60 nm), about 1000 ppm of DISPERBYK® 191, and about 0.1 percent by weight of a silicone glycol copolymeric nonionic surfactant (SILWET® L7604, OSi Specialties, Danbury Conn.; reportedly having an HLB in the range of about 5 to 8) in combination with about 1 percent by weight of IDA. The wafers were polished on a Logitech Model II CDP polisher (Logitech Ltd., Glasgow, UK) in the presence of about 0.8 percent by weight hydrogen peroxide or 0.1 percent by weight periodic acid, at a pH of about 7, under the following operating conditions: a D100 polishing pad, platen speed of about 80 rpm, carrier speed of about 75 rpm, down force of about 1 psi or 3 psi, and a slurry flow rate of 150 mL/min. In each case, the copper removal rate at 1 psi down force was about 1200 Å/min and the removal rate at 3 psi was about 3200 Å/min. The static etch rate for the composition was about 18 Å/min with each oxidizing agent.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A chemical-mechanical polishing (CMP) composition for polishing a copper-containing substrate, the composition comprising:
(a) not more than about 1 percent by weight of a particulate abrasive;
(b) a polyelectrolyte;
(c) a copper-complexing agent; and
(d) an aqueous carrier therefor.

2. The composition of claim 1 wherein the polyelectrolyte has a weight average molecular weight of at least about 10,000 grams-per-mole (g/mol).

3. The composition of claim 1 wherein the polyelectrolyte comprises an anionic or amphoteric polymer.

4. The composition of claim 1 wherein the polyelectrolyte comprises an acrylic acid polymer or copolymer.

5. The composition of claim 1 wherein the copper-complexing agent comprises an amino polycarboxylate.

6. The composition of claim 1 wherein the polyelectrolyte comprises a cationic polymer.

7. The composition of claim 1 wherein the copper-complexing agent comprises an amino acid.

8. The composition of claim 1 wherein the polyelectrolyte is present in the composition at a concentration in the range of about 50 to about 1000 ppm.

9. The composition of claim 1 wherein the copper-complexing agent is present in the composition at a concentration in the range of about 0.5 to about 1.5 percent by weight.

10. The composition of claim 1 wherein the particulate abrasive has a mean particle size of not more than about 100 nm.

11. The composition of claim 1 wherein the particulate abrasive comprises at least one metal oxide selected from the group consisting of titanium dioxide and silicon dioxide.

12. A chemical-mechanical polishing (CMP) composition for polishing a copper-containing substrate, the composition comprising:
(a) not more than about 1 percent by weight of a particulate abrasive having a mean particle size of not more than about 100 nm;
(b) about 100 to about 1000 ppm of an anionic or amphoteric polyelectrolyte;
(c) about 0.5 to about 1.5 percent by weight of an amino polycarboxylate copper-complexing agent; and
(d) an aqueous carrier therefor.

13. The composition of claim 12 wherein the polyelectrolyte has a weight average molecular weight of at least about 50,000 grams-per-mole (g/mol).

14. The composition of claim 12 wherein the polyelectrolyte comprises an acrylic acid polymer or copolymer.

15. The composition of claim 12 wherein the polyelectrolyte comprises an acrylic acid-acrylamide copolymer.

16. The composition of claim 12 wherein the amino polycarboxylate comprises iminodiacetic acid or a salt thereof.

17. The composition of claim 12 wherein the particulate abrasive comprises at least one metal oxide selected from the group consisting of titanium dioxide and silicon dioxide.

18. A chemical-mechanical polishing (CMP) composition for polishing a copper-containing substrate, the composition comprising:
(a) not more than about 1 percent by weight of a particulate abrasive having a mean particle size of not more than about 100 nm;
(b) about 10 to about 150 ppm of an cationic polyelectrolyte;
(c) about 0.5 to about 1.5 percent by weight of an amino acid copper-complexing agent; and
(d) an aqueous carrier therefor.

19. The composition of claim 18 wherein the polyelectrolyte has a weight average molecular weight of at least about 15,000 grams-per-mole (g/mol).

20. The composition of claim 18 wherein the cationic polyelectrolyte comprises poly(2-[(methacryloyloxy)ethyl]trimethylammonium chloride).

21. The composition of claim 18 wherein the amino acid comprises glycine.

22. The composition of claim 18 wherein the particulate abrasive comprises at least one metal oxide selected from the group consisting of titanium dioxide and silicon dioxide.

23. A method of polishing a copper-containing substrate, which comprises abrading a surface of the substrate with a CMP composition of claim 1, optionally in the presence of an oxidizing agent.

24. The method of claim 23 wherein the CMP composition comprises about 100 to about 1000 ppm of the polyelectrolyte and about 0.5 to about 1.5 percent by weight of the copper-complexing agent, the polyelectrolyte comprises an anionic or amphoteric polymer, and the copper-complexing agent comprises an amino polycarboxylate compound.

25. The method of claim 23 wherein the CMP composition comprises about 10 to about 150 ppm of the polyelectrolyte and about 0.5 to about 1.5 percent by weight of the copper-complexing agent, the polyelectrolyte comprises a cationic polymer, and the copper-complexing agent comprises an amino acid.
